(19) United States
(12) Patent Application Publication
(10) Pub. No.: US 2026/0167387 A1
(43) Pub. Date: Jun. 18, 2026

(54) TOOL BUCKET SUPPORT

(71) Applicant: Cynthia DeLaittre, Simi Valley, CA (US)

(72) Inventor: Cynthia DeLaittre, Simi Valley, CA (US)

(21) Appl. No.: 19/367,525

(22) Filed: Oct. 23, 2025

Related U.S. Application Data
(60) Provisional application No. 63/715,357, filed on Nov. 1, 2024.

(51) Int. Cl. B65D 25/24; B25H 3/02

(52) U.S. Cl. CPC B65D 25/24; B25H 3/02

(57) ABSTRACT

A tool support device includes a tool container and a fitment for attaching the tool container to a framing member.

### BENEFIT CLAIM

This application claims the benefit of U.S. Prov. Pat. App. No. 63/715,357 entitled Tool Bucket Support filed Nov. 1, 2024.

### BACKGROUND OF THE INVENTION

### Field of the Invention

The present invention relates to an article of manufacture for gathering and/or containing tools. In particular, a workman is aided by a tool container such as a bucket that includes or is used with a fixture that attaches the tool container to the framing member(s) of a structure. The framing members may be metal or wood, for example, the ceiling joists of a wood frame building under construction, the attached tool container providing ready access to tools used by the workman.

### Discussion of the Related Art

Tools used by a workman during the repair, maintenance, or construction of a structure such as an elevated portion of a structure are typically carried in a tool belt worn by the workman. The tool belt solution for providing access to various tools is limited by the number of tools that can be carried in this manner and also by the size/weight of the tools that are to be carried. For example, where a multiplicity of tools or a large/heavy/long tool is needed by the workman, the tool or tools must typically be retrieved from below which often requires yet another workman to provide the tool(s) to the workman above.

### SUMMARY OF THE INVENTION

In various embodiments, a tool container such as a bucket includes or is used with a fixture that attaches the tool container to a framing member. The fixture is designed to include a pocket or pockets (which may be a notch or notches) that receive a portion(s) of a framing member in a manner that supports and/or holds the tool container upright. The tool container may incorporate the fixture as would be the case for a single part or multiple parts affixed together or the tool container may be removably carried by the fixture as in the case of a fixture in the form of a sleeve that captures and supports or holds the tool container. The tool container or bucket and the sleeve may be made of plastic.

In some embodiments, the present invention may include a sleeve accessory that utilizes a dual notch designed for buckets such as 5-gallon tool buckets, specifically engineered with two crossing notches on the bottom of the sleeve. This accessory may facilitate convenient storage and accessibility of tools where there is no flooring, such as attics or during house framing, enhancing efficiency and safety for construction trades. In various embodiments the sleeve bottom may be a partial bottom or a complete bottom. In some embodiments the complete bottom may be formed using a plastic sleeve closed at the bottom end where the notch or notches are formed for example via injection molding, mandril forming, or a similarly useful technique.

In some embodiments, the dual-notch sleeve accessory is designed for 5-gallon tool buckets to provide easy tool access in areas supported only by ceiling or floor joists, where conventional flooring may not be present. It is also ideal for construction projects using 2×4 lumber, where convenient tool accessibility is crucial.

In some embodiments, the accessory consists of a cylindrical sleeve made from plastic, featuring both a 2-inch and 4-inch notch. These notches allow the sleeve to securely fit on joists of various sizes (like 2×6, 2×8, 2×10, etc.) and 4-inch wide lumber.

In some embodiments, the sleeve accommodates a standard 5-gallon tool bucket commonly used in construction and trades. It enables the bucket to rest securely on ceiling or floor joists in attics and other framed construction projects. Here, the notches may be engineered to prevent slipping or shifting of the bucket, ensuring the tools and materials stored inside remain stable and secure.

In an embodiment the tool bucket support comprises: a sleeve holding a five gallon bucket, the bucket holding woodworking tools; the tool bucket removably fitted into and protruding from the sleeve; a lower end of the sleeve having a notch and, the notch sized to receive a first ceiling joist; wherein the fitment of the bucket to the sleeve and the fitment of the notch to the ceiling joist tends to hold the bucket upright allowing a workman standing on adjacent ceiling joists to access the tools.

In an embodiment, the notch or notches seize the wooden member inserted therein. In an embodiment the notch or notches seize a ceiling joist inserted therein.

Various embodiments include various advantages. For example, embodiments may have one or more of the following advantages:
Enable easy storage and access to tools such as tools used by a framer and materials such as materials used by a framer in spaces supported solely by ceiling or floor joists, like attics or during house framing;
Increase safety and efficiency by eliminating the need for frequent ladder climbs to retrieve tools, saving both time and effort; and,
Enhance safety by providing a stable platform for the bucket, reducing the risk of spills or accidents due to unstable placements and minimizing the risk of ladder falls.

As seen, various embodiments of the dual-notch sleeve accessory for 5-gallon tool buckets provide advancements in convenience and safety for the construction trades. These embodiments may be designed to securely fit on both horizontal and vertical orientations of 2-inch and 4-inch wide lumber and to facilitate efficient storage and convenient access to tools and materials in elevated environments lacking flooring. These embodiments may also boost productivity and minimize potential risks, thereby providing a valuable solution for professionals working in demanding construction settings.

### BRIEF DESCRIPTION OF THE DRAWINGS

The present invention is described with reference to the accompanying figures. These figures, incorporated herein and forming part of the specification, illustrate the present invention and, together with the description, further explain the principles of the invention and to enable a person skilled in the relevant art to make and use the invention.

FIG. 1 shows a two part embodiment of the tool bucket support, the first part or bucket being separated from the second part or sleeve.

FIGS. 2 and 3 show an embodiment of the tool bucket support using plan views of the bucket and sleeve.

FIGS. 4 and 5 show an embodiment of the tool bucket support sleeve using perspective side views.

FIGS. 6 and 7 show an embodiment of the tool bucket support with the bucket inserted in the sleeve and with sleeve notches fitted to a framing member.

FIG. 8 shows the anatomy of roof framing parts.

### DETAILED DESCRIPTION OF THE PREFERRED EMBODIMENTS

The disclosure provided in the following pages describes examples of some embodiments of the invention. The designs, figures, and descriptions are non-limiting examples of certain embodiments of the invention. For example, other embodiments of the disclosed device may or may not include the features described herein. Moreover, disclosed advantages and benefits may apply to only certain embodiments of the invention and should not be used to limit the disclosed inventions.

The invention provides a container for tools or other items used by a workman while working on an elevated structure.

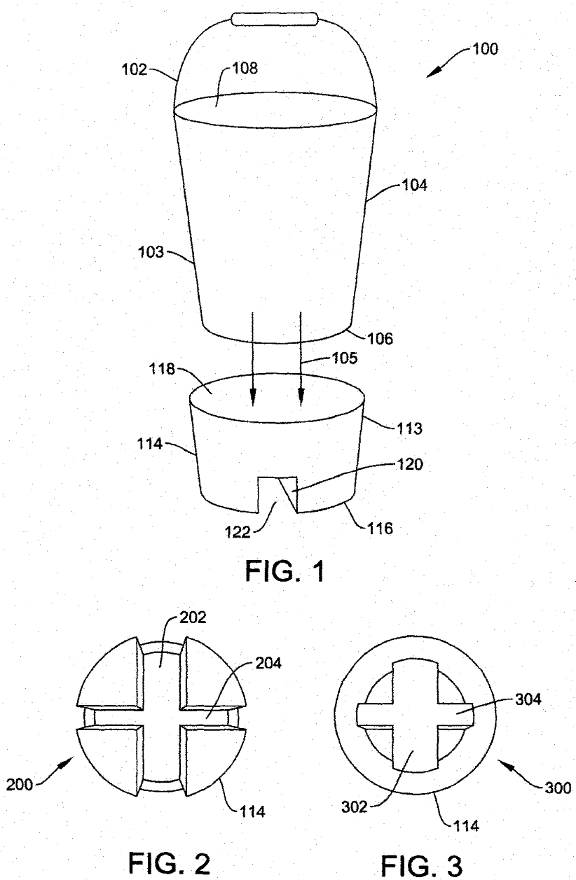

FIG. 1 shows an embodiment of the invention including two parts 100. An upper part or body 104 is a container or bucket (“bucket”) with a top end opening 108, a bottom 106, and a bail 102. A lower part or body is in the form of a modified sleeve 114 having a top end opening 118, a bottom end 116 which may be open or closed, and one or more slots 122 with side walls 120 (one shown) through the bottom end. The sleeve body 114 and/or the bucket body 104 may have sloped side walls 103, 113. In some embodiments the sleeve sloped side walls are formed to interfere with and to press against the bucket side walls when the bucket is inserted 105 into the sleeve such that the sleeve holds the bucket.

Notably, in other embodiments (not shown), the tool bucket support may be of an integral design such that there is a single part combining the bucket and the sleeve. For example, a single part by virtue of a single forming operation as with plastic, or a single part by virtue of a permanent attachment of the sleeve and bucket portions.

FIGS. 2 and 3 show an exterior and an interior plan views of an embodiment of the sleeve 200, 300. Here there are two sleeve notches (dual-notch) 202, 204 and/or 302, 304 for mating with one or two framing members of the same size or of different sizes. In some embodiments a bucket inserted in the sleeve rests on the projections of the notches internal to the sleeve, for example projections 302, 304.

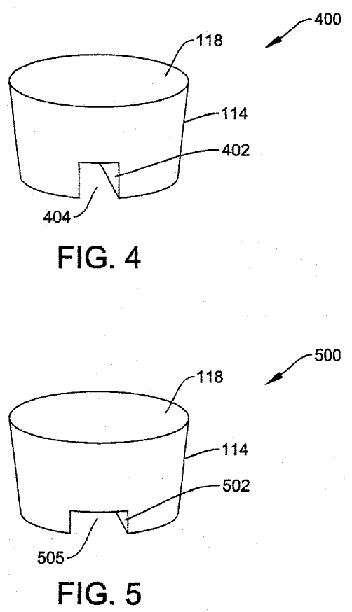

FIGS. 4 and 5 show perspective views of an embodiment of the sleeve 400, 500. In FIG. 4, the sleeve is rotated to illustrate a first notch 404 with sidewall 402. In FIG. 5, the sleeve is rotated to illustrate a second notch 505 with sidewall 502. This second notch may be larger than the notch of FIG. 4. Each of the notches is sized and designed to fit over a framing member and to thereby stabilize a bucket which is fitted to the sleeve.

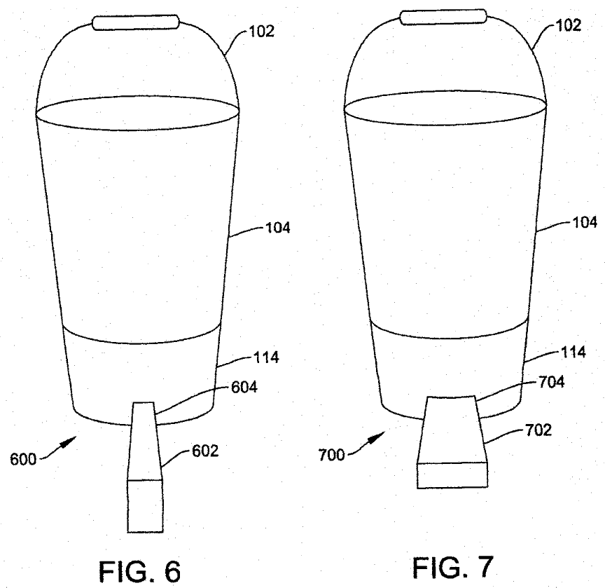

FIGS. 6 and 7 show perspective views of an embodiment of the bucket fitted into the sleeve 600, 700. In FIG. 6, the bucket is held upright by an attachment of the sleeve to a framing member 602 of a first size, the attachment using a sleeve notch 604. In FIG. 7, the bucket is held upright by an attachment of the sleeve to a framing member 702 of a second size, the attachment using a sleeve notch 704. In some embodiments, the sleeve 114 includes both the first notch and the second notch which may or may not be of equal sizes.

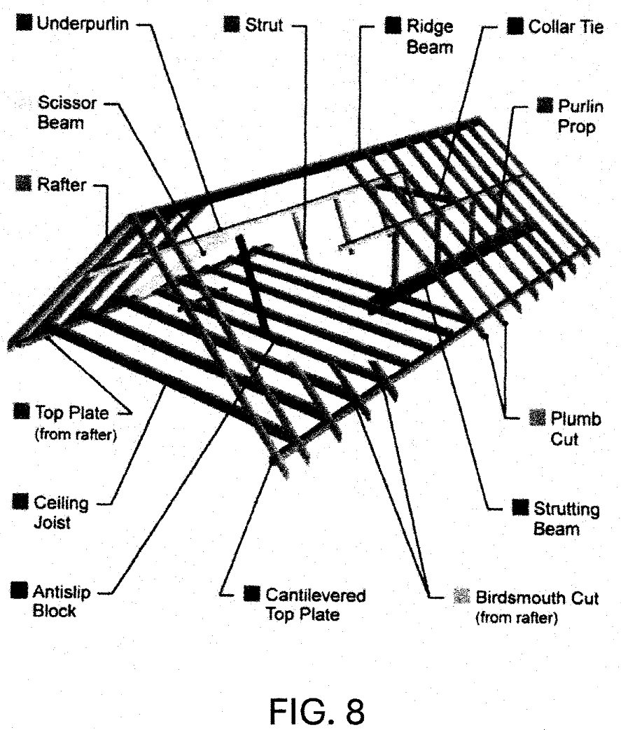

FIG. 8 shows an annotated anatomy of roof framing parts 800. Further concerning use of the tool bucket support, in some embodiments its notch or notches may be engaged with any particular one or more of the annotated members shown on the figure. For example, in various embodiments the tool bucket support notch or notches may be engaged with a ceiling joist, a ridge beam, a collar tie, a strutting beam, or any other member wherein free sliding of the tool bucket support along the member is prevented or preventable.

While various embodiments of the present invention have been described above, they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is

1. A tool bucket support comprises:
a five gallon cylindrical bucket inserted in a sleeve, the bucket holding tools used by a framer;
the tool bucket removably fitted into and protruding from the sleeve with a bottom;
a lower end of the sleeve having a notch or notches formed by the bottom; and,
the notch or notches sized to receive a first ceiling joist;
wherein the fitment of the bucket to the sleeve and the fitment of the notch or notches to the ceiling joist tends to hold the bucket upright allowing a workman standing on adjacent ceiling joists to access the tools.

2. The tool bucket support of claim 1 wherein the notch or notches seize the ceiling joist.

3. A tool bucket support comprises:
a sleeve holding a five gallon bucket, the bucket holding tools used by any of the construction trades;
the tool bucket removably fitted into and protruding from the sleeve;
a lower end of the sleeve having a notch or notches; and,
the notch or notches sized to receive a first ceiling joist;
wherein the fitment of the bucket to the sleeve and the fitment of the notch or notches to the ceiling joist tends to hold the bucket upright allowing a workman standing on adjacent ceiling joists to access the tools.

4. The tool bucket support of claim 3 wherein the sleeve captures less than half of the bucket height.

5. A method of removably fixing a framer's tool bucket to the wooden ceiling joists of a building under construction comprising the steps of:
providing a five gallon cylindrical plastic bucket for holding tools used by a framer;
providing a sleeve and forming a notch or notches in a bottom end of the sleeve;
removably inserting a lower portion of the bucket in the sleeve such that it rests on internal projections of the notch or notches;
sizing the notch or notches to receive a wooden ceiling joist; and,
wherein the fitment of the bucket into the sleeve and the fitment of the notch or notches onto the ceiling joist tends to hold the bucket upright allowing a workman standing on adjacent ceiling joists to access the tools.
